(19) United States
(12) Patent Application Publication
(10) Pub. No.: US 2023/0024579 A1
(43) Pub. Date: Jan. 26, 2023

(54) THERMOPLASTIC COPOLYMERS WITH A HIGH SULPHUR CONTENT AND PROCESS FOR THE PREPARATION THEREOF

(71) Applicant: ENI S.P.A., Roma (IT)

(72) Inventors: Alberto Renato DE ANGELIS, San Donato Milanese (IT); Marco GUIDOLIN, Marghera (IT); Roberto SCATTOLIN, Marghera (IT)

(21) Appl. No.: 17/782,859

(22) PCT Filed: Dec. 3, 2020
(86) PCT No.: PCT/IB2020/061451

§ 371 Date: Jun. 6, 2022

(30) Foreign Application Priority Data
Dec. 5, 2019 (IT) 102019000023070

(51) Int. Cl. C08G 61/08; C08K 3/06; C08G 75/14

(52) U.S. Cl. CPC C08G 61/08; C08K 3/06; C08G 75/14; C08G 2261/20; C08G 2261/3325

(57) ABSTRACT

A thermoplastic copolymer with a high sulphur content, having sulphur in an amount greater than or equal to 40% by weight, in relation to the total weight of the thermoplastic copolymer with a high sulphur content and at least one monomer having general formula (I):

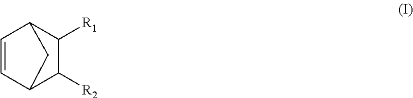

wherein:
R₁ and R₂, equal or different from each other, represent a hydrogen atom;
or R₁ and R₂, may optionally be bound together so as to form, together with the other atoms to which they are bound, a cycloalkene containing from 4 to 6 carbon atoms, saturated, unsaturated, or aromatic, optionally substituted with C₁-C₂₀ alkyl groups;
   the monomer having general formula (I) being present in an amount less than or equal to 60% by weight;
   the thermoplastic copolymer with high sulphur content having a complex dynamic viscosity (η*), at 160° C., comprised between 1×10⁴ Pa.s and 8×10⁶ Pa.s.

### TECHNICAL FIELD

The present disclosure relates to a thermoplastic copolymer with a high sulphur content.

More in particular, the present disclosure relates to a thermoplastic copolymer with a high sulphur content comprising sulphur in an amount greater than or equal to 40% by weight, preferably comprised between 45% by weight and 90% by weight, in relation to the total weight of said thermoplastic copolymer with a high sulphur content and at least one monomer having a norbornene structure greater than or equal to 60% by weight, preferably comprised between 10% by weight and 55% by weight, in relation to the total weight of said thermoplastic copolymer with a high sulphur content, said thermoplastic copolymer with a high sulphur content having a dynamic complex viscosity (η*), at 160° C., comprised between 1×10⁴ Pa.s and 8×10⁶ Pa.s, preferably comprised between 2×10⁴ Pa.s and 8×10⁵ Pa.s.

The present disclosure also relates to a process for the preparation of said thermoplastic copolymer with a high sulphur content.

Said thermoplastic copolymer with a high sulphur content has good mechanical properties and can be processed using common techniques of the polymer industry, in particular through hot moulding. Said thermoplastic copolymer with a high sulphur content can be advantageously used, as such, or mixed with other (co)polymers (for example, styrene, divinylbenzene), in different applications such as, for example, packaging, electronics, household appliances, computer cases, CD cases, kitchen, laboratory, office and medical items, building and construction industries.

### BACKGROUND

It is known that in the oil industry during the production of natural gas and oil, increasingly large amounts of elemental sulphur are produced, the surplus of which currently exceeds a million tonnes per year with a tendency to increase further as new fields are developed in which the hydrogen sulphide (H₂S) content and the elemental sulphur content are increasingly significant. The world surplus production of sulphur not only generates a depression of the market price thereof, for which the transport costs can have a negative effect on its sale, but it can also be the cause of significant environmental problems caused by the storage of significant amounts of elemental sulphur. In fact, if the storage is in the open air or underground, the aggression of the atmospheric agents can cause contamination of the surrounding areas. On this point, for example, the phenomenon known as “dusting” or dispersion of sulphur powder can be remembered which, in turn, through oxidation, can produce acidic substances (for example, sulphuric acid).

Studies have been performed for the purpose of using elemental sulphur for preparing polymers with a high sulphur content.

For example, patent application U.S. 2014/0199592 describes a polymer composition comprising a sulphur copolymer, in an amount of at least about 50% by weight in relation to the copolymer, and one or more monomers selected from the group consisting of ethylenically unsaturated monomers, epoxy monomers, thiirane monomers, in an amount comprised between about 0.1% by weight and about 50% by weight in relation to the copolymer. In the definition of ethylenically unsaturated monomers cyclopentadiene compounds such as cyclopendadiene and dicyclopentadiene are specifically excluded. The aforesaid polymer composition with a high sulphur content is said to be advantageously usable in electrochemical cells and in optical elements.

Griebel J. J. et al, in “Advanced Materials” (2014), Vol. 26, pag. 3014-3018, describe the preparation of thermoplastic copolymers with a high sulphur content obtained through the inverse vulcanization technique by reacting sulphur and 1,3-diisopropenylbenzene (DIB). The aforesaid thermoplastic copolymers with a high sulphur content are said to have good transparency in the IR spectrum and a high refractive index (n˜1.8). Furthermore, the aforesaid thermoplastic copolymers with a high sulphur content are said to be advantageously usable as optical materials transparent to infra-red light.

However, the copolymers with a high sulphur content reported above, in particular at temperatures lower than their glass transition temperature, are fragile. Furthermore, said copolymers with a high sulphur content can only be advantageously used for particular applications.

### SUMMARY

The Applicant therefore set out to solve the problem of finding copolymers with a high sulphur content able to be advantageously used in fields of wide consumption where rigidity and therefore high glass transition temperatures (T_{g}) are required and able to be processed using the common techniques of the polymer industry, in particular hot moulding.

The Applicant has now found thermoplastic copolymers with a high sulphur content having complex dynamic viscosity (η*), at 160° C., less than or equal to 8×10⁶ Pa.s, a high glass transition temperature (T_{g}) [i.e. a glass transition temperature (T_{g}) greater than or equal to 80° C.] and good mechanical properties. Thanks to their characteristics, said thermoplastic copolymers with a high sulphur content are rigid and can be processed using common techniques of the polymer industry, in particular through hot moulding. Also, thanks to the aforesaid characteristics, said thermoplastic copolymers with a high sulphur content can be advantageously used in different applications such as, for example, packaging, electronics, household appliances, computer cases, CD cases, kitchen, laboratory, office and medical items, building and construction industries. Furthermore, said thermoplastic copolymers with a high sulphur content have a much lower cost in relation to the polymers normally used in said applications such as, for example, styrene, phenol resins. Furthermore, said thermoplastic copolymers with a high sulphur content do not only allow large amount of sulphur to be used for their production, thus reducing the surplus thereof, but also to avoid the use of carcinogenic substances (for example, formaldehyde in the case of producing phenol resins).

Therefore, the subject matter of the present disclosure is a thermoplastic copolymer with a high sulphur content comprising sulphur in an amount greater than or equal to 40% by weight, preferably comprised between 45% by weight and 90% by weight, in relation to the total weight of said thermoplastic copolymer with a high sulphur content and at least one monomer having general formula (I):

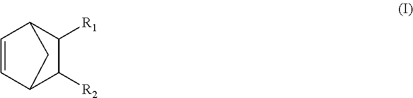

wherein
R₁ and R₂, equal or different from each other, represent a hydrogen atom; or they are selected from C₁-C₂₀, preferably C₁-C₁₅, linear or branched alkyl groups, C₂-C₂₀, preferably C₂-C₁₅, linear or branched alkenyl groups, C₂-C₂₀, preferably C₂-C₁₅, linear or branched alkylidene groups;
or R₁ and R₂ may optionally be bound together so as to form, together with the other atoms to which they are bound, a cycloalkene containing from 3 to 6 carbon atoms, saturated, unsaturated, or aromatic, optionally substituted with C₁-C₂₀ alkyl groups, preferably C₁-C₁₅, linear or branched, said cycle optionally containing heteroatoms such as, for example, oxygen, sulphur, nitrogen, silicon, phosphorus, selenium;
   said monomer having general formula (I) being present in an amount less than or equal to 60% by weight, preferably comprised between 10% by weight and 55% by weight, in relation to the total weight of said thermoplastic copolymer with a high sulphur content;
   said thermoplastic copolymer with a high sulphur content having a complex dynamic viscosity (η*), at 160° C., comprised between 1×10⁴ Pa.s and 8×10⁶ Pa.s, preferably comprised between 2×10⁴ Pa.s and 8×105 Pa.s.

Said complex dynamic viscosity (η*) was determined by dynamic mechanical analysis (DMA) which was performed as reported below in the paragraph “Analysis and characterization methods”.

For the purpose of the present description and the following claims, the definitions of the numerical intervals always comprise the extreme values unless otherwise specified.

For the purpose of the present description and the following claims, the term “comprising” also includes the terms “which essentially consists of” or “which consists of”.

For the purpose of the present description and the following claims, the term “C₁-C₂₀ alkyl groups” means alkyl groups having from 1 to 20 carbon atoms, linear or branched. Specific examples of C₁-C₂₀ alkyl groups are: methyl, ethyl, n-propyl, iso-propyl, n-butyl, s-butyl, iso-butyl, tert-butyl, pentyl, hexyl, heptyl, octyl, n-nonyl, n-decyl, 2-butyloctyl, 5-methylhexyl, 4-ethylhexyl, 2-ethylheptyl, 2-ethylhexyl.

For the purpose of the present description and the following claims, the term “C₂-C₂₀ alkenyl groups” means alkenyl groups having from 2 to 20 carbon atoms, linear or branched. Specific examples of C₂-C₂₀ alkenyl groups are: ethenyl (vinyl), 2-propenyl, 1-butenyl, 2-butenyl, 3-butenyl, 1-pentenyl, 2-pentenyl, 3-pentenyl, 1-hexenyl, 2-hexenyl, 3-hexenyl.

For the purpose of the present description and the following claims, the term “C₂-C₂₀ alkylidene groups” means alkylidene groups having from 2 to 20 carbon atoms, linear or branched. Specific examples of C₂-C₂₀ alkylidene groups are: ethylidene, propylidene, iso-propylidene butylidene, iso-butylidene, amylidene, iso-amylidene.

For the purpose of the present description and the following claims, the term “cycloalkene” means a system containing a ring having from 3 to 6 carbon atoms and a double bond. Specific examples of cycloalkenes are: cyclopropene, cyclobutene, cyclopentene, cyclohexene.

According to a preferred embodiment of the present disclosure, said monomer having general formula (I) can be selected, for example, from: dicyclopentadiene, 5-ethylidene-2-norbornene, 5-vinyl-2-norbornene, or mixtures thereof.

According to a preferred embodiment of the present disclosure, said thermoplastic copolymer with a high sulphur content comprises sulphur in an amount equal to 50% by weight in relation to the total weight of said thermoplastic copolymer with a high sulphur content and at least one monomer having general formula (I):

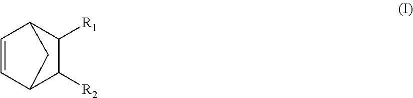

wherein R₁ and R₂ are bound together so as to form, together with the other atoms to which they are bound, a cyclopentene, said monomer having general formula (I) being present in an amounts equal to 50% by weight in relation to the total weight of said thermoplastic copolymer with a high sulphur content.

According to a further preferred embodiment of the present disclosure, said thermoplastic copolymer with a high sulphur content comprises sulphur in an amount equal to 60% by weight in relation to the total weight of said thermoplastic copolymer with a high sulphur content and at least one monomer having general formula (I):

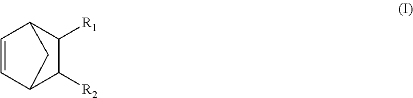

wherein R₁ and R₂ are bound together so as to form, together with the other atoms to which they are bound, a cyclopentene, said monomer having general formula (I) being present in an amount equal to 40% by weight in relation to the total weight of said thermoplastic copolymer with a high sulphur content.

According to a further preferred embodiment of the present disclosure, said thermoplastic copolymer with a high sulphur content comprises sulphur in an amount equal to 50% by weight in relation to the total weight of said thermoplastic copolymer with a high sulphur content and at least one monomer having general formula (I):

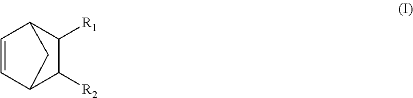

wherein R₁ is hydrogen and R₂ is ethylidene, said monomer having general formula (I) being present in an amount equal to 50% by weight in relation to the total weight of said thermoplastic copolymer with a high sulphur content.

According to a preferred embodiment of the present disclosure, said thermoplastic copolymer with a high sulphur content can have a glass transition temperature (T_{g}) greater than or equal to 80° C., preferably comprised between 85° C. and 160° C.

Said glass transition temperature (T_{g}) was determined through DSC (“Differential Scanning calorimetry”) analysis, which was performed as reported below in paragraph “Analysis and characterization methods”.

As mentioned above, the present disclosure also relates to a process for the preparation of said thermoplastic copolymer with a high sulphur content.

### DETAILED DESCRIPTION

Therefore, further subject matter of the present patent application is a process for the preparation of a thermoplastic copolymer with a high sulphur content comprising:
(i) reacting the sulphur with at least one monomer having general formula (I), in the presence of at least one radical initiator and at least one radical chain terminator, at a temperature comprised between 120° C. and 190° C., preferably comprised between 130° C. and 180° C., for a time comprised between 1 minute and 180 minutes, preferably comprised between 10 minutes and 130 minutes, thus obtaining a liquid pre-polymer;
(ii) pouring the liquid pre-polymer obtained in step (i) into a mould and keep said mould at a temperature comprised between 100° C. and 180° C., preferably comprised between 120° C. and 170° C., for a time comprised between 1 hour and 24 hours, preferably comprised between 2 hours and 18 hours, thus obtaining a thermoplastic copolymer with a high sulphur content.

According to a preferred embodiment of the present disclosure, said radical initiator is selected from: mercaptans such as, for example, 2-mercaptobenzothiazole, 2-mercaptobenzoxazole, 2-mercapto-benzimidazole, 2,5-dimercapto-1,3,4-thiadiazole, 2-mercapto-2,5-dimethylaminopyridine, or mixtures thereof alkenyl disulphides such as, for example, diallyl disulphide, allyl propyl disulphide, ethyl allyl disulphide, methyl allyl disulphide, or mixtures thereof; or mixtures thereof. Mercaptobenzothiazole, diallyl disulphide are preferred.

According to a preferred embodiment of the present disclosure, said radical initiator can be used in said step (i) in an amount less than or equal to 1% by weight, preferably comprised between 0.2% by weight and 0.5% by weight, in relation to the total weight of the reaction mixture (i.e. the mixture of sulphur+monomer+radical initiator+radical chain terminator).

According to a preferred embodiment of the present disclosure, said radical chain terminator can be selected, for example, from aliphatic, cycloaliphatic or aromatic disulphides, such as, for example, dimethyl disulphide, diethyl disulphide, dicyclohexyl disulphide, diphenyl disulphide, ditolyl disulphide, or derivatives thereof, or mixtures thereof. Diethyl disulphide, dicyclohexyl disulphide, diphenyl disulphide, are preferred.

According to a preferred embodiment of the present disclosure, said radical chain terminator can be used in said step (i) in an amount less than or equal to 15% by weight, preferably comprised between 5% by weight and 10% by weight, in relation to the total weight of the reaction mixture (i.e. the mixture of sulphur+monomer+radical initiator+radical chain terminator).

For the purpose of the process according to the present disclosure, the mould used in the aforesaid step (iii) can preferably be made of teflon or silicone.

According to a preferred embodiment of the present disclosure the sulphur used in said step (i) is elemental sulphur.

For the purpose of the process according to the present disclosure, said elemental sulphur is preferably in the form of powder or “flakes”. In environmental conditions (i.e. at ambient temperature and pressure), the elemental sulphur exists in orthorhombic crystalline form (ring with eight sides) (S₈) and has a melting point comprised between 120° C. and 124° C. Said elemental sulphur in orthorhombic crystalline form (S₈), at a temperature greater than 159° C., is subject to “Ring Opening Polymerization” (ROP) and is transformed into a linear polymer chain with two free radicals at the ends. Said linear polymer chain is metastable and therefore it tends to be reconverted to the orthorhombic crystalline form (S₈) at different speeds according to the conditions.

For the purpose of the process according to the present disclosure, said elemental sulphur is in the orthorhombic crystalline form (S₈) said form generally being the most stable, the most accessible and the least expensive. However, it is to be noted that, for the purpose of the present disclosure, other allotropic forms of sulphur can be used such as, for example, the cyclic allotropic forms deriving from thermal processes to which the elemental sulphur in orthorhombic crystalline form (S₈) can be subjected. It is also to be noted that any species of sulphur that, when heated, enables species able to be subjected to radical or anionic polymerization to be obtained, can be used for the purpose of the process according to the present disclosure.

As mentioned above, said thermoplastic copolymer with a high sulphur content can be advantageously used, as such, or mixed with other (co)polymers (for example, styrene, divinylbenzene), in different applications such as, for example, packaging, electronics, household appliances, computer cases, CD cases, kitchen, laboratory, office and medical items, building and construction industries.

Therefore, further subject matter of the present disclosure is the use of said thermoplastic copolymer with a high sulphur content, as such, or mixed with other (co)polymers (for example, styrene, divinylbenzene), in different applications such as, for example, packaging, electronics, household appliances, computer cases, CD cases, kitchen, laboratory, office and medical items, building and construction industries.

In order to better understand the present disclosure and to put it into practice, some illustrative and non-limiting examples thereof are reported below.

### EXAMPLES

### Analysis and Characterization Methodologies

The analysis and characterization methodologies reported below were used.

### DMA—“Dynamic Mechanical Analysis”

The DMA—“Dynamic Mechanical Analysis” was performed using an RMS 800 rheometer by Rheometrics Scientific, equipped with 25 mm parallel plates geometry.

For that purpose, after conditioning the sample of copolymer obtained in a drier containing silica gel, for one night, a disc shaped sample with a diameter of 25 mm and thickness of 2 mm was obtained, by hot moulding, operating as described below.

The disc shaped sample thus obtained was inserted between the parallel plates of the aforesaid rheometer and the complex viscosity (η*) was measured, at a constant temperature equal to 160° C., applying strain of 10%, as the oscillation frequency of the plates varies from 0.01 rad/s to 100 rad/s.

### Differential Scanning Calorimetry (DSC)

Differential Scanning calorimetry, for the purpose of determining the glass transition temperature (T_{g}) of the copolymers obtained, was performed using a Perkin Elmer Pyris differential scanning calorimeter, using the following thermal program:
cooling from ambient temperature (T=25° C.) to −60° C. at a speed of −5° C./minute;
heating from −60° C. to +150° C. at a speed of +10° C./minute (first scan);
cooling from +150° C. to −60° C. at a speed of −5° C./minute;
heating from −60° C. to +150° C. at a speed of +10° C./minute (second scan); operating under nitrogen (N₂) flow at 70 ml/minute.

### Hot Moulding

For that purpose, 5 g of the copolymer obtained were placed between two teflon sheets, in turn positioned between two metal sheets having the following dimensions: 25 cm×25 cm, 1 mm thick. Everything was inserted into a hot press previously brought to the final pressing temperature (160° C.) and the hot plates were moved towards one another until obtaining good contact with the metal sheets. When the softening of the copolymer was observed, after about 10 minutes, pressing began with a load of less than 1.5 tonnes. After obtaining sufficient lowering of the applied load (due to the deformation of the copolymer) the applied load was brought to a value greater than 1 tonne and less than 1.5 tonnes: said operation was repeated 2 or 3 times until obtaining a disc shaped product.

### Example 1 (Comparative)

Synthesis of Copolymer with Sulphur (60% by weight) and Dicyclopentadiene (40% by weight)

60 g of pure sulphur were loaded cold [elemental sulphur in crystalline orthorhombic form (S₈) by Sigma-Aldrich] into a 250 jacketed reactor: the reactor was heated to 140° C., through a thermostat with silicone oil circulation as working fluid. Then, through a jacketed dropping funnel, the following were added in this order: 40 g of dicyclopentadiene (purity >96%−Sigma-Aldrich) previously liquefied and 0.4 ml of diallyl disulphide (Sigma-Aldrich): everything was kept, in an inert atmosphere, under mechanical agitation through a compressed air explosion-proof agitator drill, at 140° C., for 90 minutes, obtaining a pre-polymerized fluid. The pre-polymerized fluid thus obtained was poured into a teflon mould which was closed and placed in a pre-heated oven at 140° C.: said pre-polymerized fluid was kept at said temperature, for 16 hours, obtaining a rigid, very resistant and difficult to break, black copolymer.

Said copolymer was subjected to DMA (“Dynamic Mechanical Analysis”) operating as described above, for the purpose of measuring the complex dynamic viscosity (η*). It was not possible to determine the complex dynamic viscosity (η*) as the sample crumbled.

Said copolymer was also subjected to DSC (“Differential Scanning calorimetry”) operating as described above, for the purpose of measuring the glass transition temperature (T_{g}) which was equal to 93° C.

Furthermore, said copolymer, when subjected to hot moulding operating as described above, could not be moulded as it crumbled.

### Example 2 (Disclosure)

Synthesis of Copolymer with Sulphur (60% by weight), Dicyclopentadiene (35% by weight) and Diethyl Disulphide (5% by weight)

60 g of pure sulphur were loaded cold [elemental sulphur in crystalline orthorhombic form (S₈) by Sigma-Aldrich] and 0.4 g of 2-mercaptobenzodiazole (Aldrich) into a 250 jacketed reactor: the reactor was heated to 140° C., through a thermostat with silicone oil circulation as working fluid. Then, through a jacketed dropping funnel, the following were added in this order: 35 g of dicyclopentadiene (purity>96%—Sigma-Aldrich) previously liquefied and 5 ml of diethyl disulphide (Sigma-Aldrich): everything was kept, in an inert atmosphere, under mechanical agitation through a compressed air explosion-proof agitator drill, at 160° C., for 120 minutes, obtaining a pre-polymerized fluid. The pre-polymerized fluid thus obtained was poured into a teflon mould which was closed and placed in a pre-heated oven at 160° C.: said pre-polymerized fluid was kept at said temperature, for 16 hours, obtaining a rigid, very resistant and difficult to break, black copolymer.

Said copolymer was subjected to DMA—“Dynamic Mechanical Analysis” operating as described above, for the purpose of measuring the complex dynamic viscosity (η*) which was equal to 7×10⁵ Pa.s.

Said copolymer was also subjected to DSC (“Differential Scanning calorimetry”) operating as described above, for the purpose of measuring the glass transition temperature (T_{g}) which was equal to 88° C.

Furthermore, said copolymer, when subjected to hot moulding operating as described above, could be moulded as it appeared deformed but uniform, cohesive, in a single body and with a relaxed surface.

### Example 3 (Disclosure)

Synthesis of Copolymer with Sulphur (60% by weight), Dicyclopentadiene (35% by weight) and Dicyclohexyl Disulphide (5% by weight)

60 g of pure sulphur were loaded cold [elemental sulphur in crystalline orthorhombic form (S₈) by Sigma-Aldrich] and 0.4 g of 2-mercaptobenzodiazole (Aldrich) into a 250 jacketed reactor: the reactor was heated to 140° C., through a thermostat with silicone oil circulation as working fluid. Then, through a jacketed dropping funnel, the following were added in this order: 35 g of dicyclopentadiene (purity>96%—Sigma-Aldrich) previously liquefied and 4.8 ml of dicyclohexyl disulphide (Sigma-Aldrich): everything was kept, in an inert atmosphere, under mechanical agitation through a compressed air explosion-proof agitator drill, at 160° C., for 120 minutes, obtaining a pre-polymerized fluid. The pre-polymerized fluid thus obtained was poured into a teflon mould which was closed and placed in a pre-heated oven at 160° C.: said pre-polymerized fluid was kept at said temperature, for 16 hours, obtaining a rigid, very resistant and difficult to break, black copolymer.

Said copolymer was subjected to DMA—“Dynamic Mechanical Analysis” operating as described above, for the purpose of measuring the complex dynamic viscosity (η*) which was equal to 6×10⁵ Pa.s.

Said copolymer was subjected to DSC (“Differential Scanning calorimetry”) operating as described above, for the purpose of measuring the glass transition temperature (T_{g}) which was equal to 98° C. Said copolymer was very resistant and difficult to break.

Furthermore, said copolymer, when subjected to hot moulding operating as described above, could be moulded as it appeared deformed but uniform, cohesive, in a single body and with a relaxed surface.

1. A thermoplastic copolymer with a high sulphur content, comprising sulphur in an amount greater than or equal to 40% by weight, in relation to the total weight of said thermoplastic copolymer with a high sulphur content and at least one monomer having general formula (I): 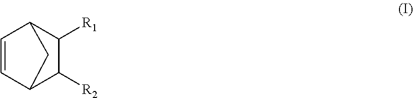
wherein:
R₁ and R₂, equal or different from each other, represent a hydrogen atom; or they are selected from C₁-C₂₀, preferably C₁-C₁₅, linear or branched alkyl groups, C₂-C₂₀, preferably C₂-C₁₅, linear or branched alkenyl groups, C₂-C₂₀, preferably C₂-C₁₅, linear or branched alkylidene groups;
or R₁ and R₂ may optionally be bound together so as to form, together with the other atoms to which they are bound, a cycloalkene containing from 3 to 6 carbon atoms, saturated, unsaturated, or aromatic, optionally substituted with C₁-C₂₀ alkyl groups, preferably C₁-C₁₅, linear or branched, said cycle optionally containing heteroatoms such as, for example, oxygen, sulphur, nitrogen, silicon, phosphorus, selenium;
said monomer having general formula (I) being present in an amount less than or equal to 60% by weight, in relation to the total weight of said thermoplastic copolymer with a high sulphur content;
said thermoplastic copolymer with a high sulphur content having a complex dynamic viscosity (η*), at 160° C., comprised between 1×10⁴ Pa.s and 8×10⁶ Pa.s.

2. The thermoplastic copolymer with a high sulphur content according to claim 1, wherein said monomer having general formula (I) is selected from the group consisting of dicyclopentadiene, 5-ethylidene-2-norbornene, 5-vinyl-2-norbornene, and mixtures thereof.

3. The thermoplastic copolymer with a high sulphur content according to claim 1, wherein said thermoplastic copolymer with a high sulphur content comprises sulphur in an amount equal to 50% by weight in relation to the total weight of said thermoplastic copolymer with a high sulphur content and at least one monomer having general formula (I): 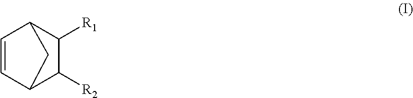
wherein R₁ and R₂ are bound together so as to form, together with the other atoms to which they are bound, a cyclopentene, said monomer having general formula (I) being present in an amount equal to 50% by weight in relation to the total weight of said thermoplastic copolymer with a high sulphur content.

4. The thermoplastic copolymer with a high sulphur content according to claim 1, wherein said thermoplastic copolymer with a high sulphur content comprises sulphur in an amount equal to 60% by weight in relation to the total weight of said thermoplastic copolymer with a high sulphur content and at least one monomer having general formula (I): 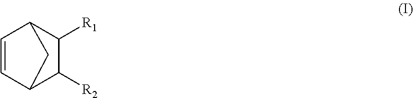
wherein R₁ and R₂ are bound together so as to form, together with the other atoms to which they are bound, a cyclopentene, said monomer having general formula (I) being present in an amount equal to 40% by weight in relation to the total weight of said thermoplastic copolymer with a high sulphur content.

5. The thermoplastic copolymer with a high sulphur content according to claim 1, wherein said thermoplastic copolymer with a high sulphur content comprises sulphur in an amount equal to 50% by weight in relation to the total weight of said thermoplastic copolymer with a high sulphur content and at least one monomer having general formula (I): 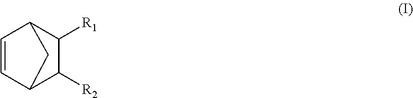
wherein R₁ is hydrogen and R₂ is ethylidene, said monomer having general formula (I) being present in an amount equal to 50% by weight in relation to the total weight of said thermoplastic copolymer with a high sulphur content.

6. The thermoplastic copolymer with a high sulphur content according to claim 1, wherein said thermoplastic copolymer with a high sulphur content has a glass transition temperature (T_{g}) greater than or equal to 80° C.

7. A method for the preparation of a thermoplastic copolymer with a high sulphur content, the method including the following steps:
(i) reacting the sulphur with at least one monomer having general formula (I), in the presence of at least one radical initiator and at least one radical chain terminator, at a temperature comprised between 120° C. and 190° C., for a time comprised between 1 minute and 180 minutes, thus obtaining a liquid pre-polymer, and
(ii) pouring the liquid pre-polymer obtained in step (i) into a mould and keep said mould at a temperature comprised between 100° C. and 180° C., for a time comprised between 1 hour and 24 hours, thus obtaining a thermoplastic copolymer with a high sulphur content.

8. The method for the preparation of a thermoplastic copolymer with a high sulphur content according to claim 7, wherein:
said radical initiator is selected from the group consisting of mercaptans, such as 2-mercaptobenzothiazole, 2-mercaptobenzoxazole, 2-mercapto-benzimidazole, 2,5-dimercapto-1,3,4-thiadiazole, 2-mercapto-2,5-dimethylaminopyridine, and mixtures thereof; alkenyl disulphides, such as diallyl disulphide, allyl propyl disulphide, allyl ethyl disulphide, allyl methyl disulphide, or mixtures thereof; and mixtures thereof,
said radical initiator is used in said step (i) in an amount lower than or equal to 1% by weight, in relation to the total weight of the reaction mixture (i.e. the mixture of sulphur+monomer+radical initiator+radical chain terminator), and/or
said radical chain terminator is selected from the group consisting of aliphatic, cycloaliphatic and aromatic disulphides, such as dimethyl disulphide, diethyl disulphide, dicyclohexyl disulphide, diphenyl disulphide, ditolyl disulphide, or derivatives thereof, and mixtures thereof, and/or
said radical chain terminator is used in said step (i) in an amount lower than or equal to 15% by weight, in relation to the total weight of the reaction mixture (i.e. the mixture of sulphur+monomer+radical initiator).

9. The method for the preparation of a thermoplastic copolymer with a high sulphur content according to claim 7, wherein the sulphur used in said step (i) is elemental sulphur.

10. Use of a thermoplastic copolymer with a high sulphur content according to claim 1, as is or mixed with other (co)polymers, such as styrene, divinylbenzene, in packages, electronics, household appliances, computer cases, CD cases, kitchen, laboratory, office and medical items, building and construction industries.
